(19) United States
(12) Patent Application Publication
(10) Pub. No.: US 2015/0095124 A1
(43) Pub. Date: Apr. 2, 2015

(54) Method and System for Realtime Display or Distribution of Advertisements

(71) Applicant: Cellco Partnership d/b/a Verizon Wireless, Basking Ridge, NJ (US)

(72) Inventors: Michelle Felt, Randolph, NJ (US); Arulvadivel Venugopal, Franklin Park, NJ (US); Venkat Gaddam, Bridgewater, NJ (US)

(21) Appl. No.: 14/039,635

(22) Filed: Sep. 27, 2013

(51) Int. Cl. G06Q 30/02

(52) U.S. Cl. CPC G06Q 30/0259; G06Q 30/0264; G06Q 30/0266
USPC 705/14.5; 705/14.57

(57) ABSTRACT

A system and method for displaying marketing content at a predetermined location and at a predetermined time is disclosed. The marketing content may be displayed on a mobile vehicle unit and also distributed to a mobile device within the proximity of the mobile vehicle unit. Various categories or criteria may be tagged to the marketing content and may be displayed or distributed only when the various criteria are satisfied. The displays may be mobile or non-mobile and the marketing content, or variations of the marketing content, may be displayed on both the mobile displays or non-mobile displays, either at the same time or at different times.

### FIELD OF THE INVENTION

The field of the present invention relates generally to the delivery of advertisements to mobile devices in realtime or near realtime.

### BACKGROUND

Advertisements seen by people on the go are typically static and unchanging and often do not relate to the particular location of the advertisement or time of display, For example, advertisements seen on buses, semi-trucks, smartphones or even billboards are often only modified at low frequency. Further, advertisements on buses, semi-trucks, or other vehicles are often in a non-digital format that prevents them from being updated continually and further prevents presenting advertisements to passers-by in a realtime or near realtime basis. Such static advertisements quickly become outdated and are generally incapable of presenting advertisements based on the location of the advertisement or time of display. Moreover, conventional advertisements displayed in public are generally not personalized to potential customers that happen to be in sight of the advertisement. And advertisements that may be updated frequently on a display typically lack the ability to display an updated advertisement and then “push” the same or a similar advertisement/incentive to a nearby potential customer's mobile device.

### BRIEF DESCRIPTION OF THE DRAWINGS

In order to facilitate a fuller understanding of the exemplary embodiments, reference is now made to the appended drawings, in which like reference characters are used to indicate like elements. These drawings should not be construed as limiting, but are intended to be exemplary only.

FIG. 1 depicts a block diagram of a system architecture for processing and managing marketing content, according to an exemplary embodiment;

FIG. 2A depicts a block diagram of a hardware module at a mobile unit for processing, managing, displaying, and delivering marketing content, according to an exemplary embodiment;

FIG. 2B depicts a block diagram of a hardware module at an ad server unit for processing, managing, and delivering marketing content, according to an exemplary embodiment;

FIGS. 3A-3C depicts marketing content changing based on time and/or location, and delivery of marketing content from a mobile unit to a mobile device, according to an exemplary embodiment of the invention;

FIG. 4 depicts an illustrative flow for processing, displaying, and delivering marketing content, according to an exemplary embodiment;

FIG. 5 depicts a block diagram of a hardware module at a mobile device for processing, managing, and displaying, marketing content according to an exemplary embodiment of the invention;

FIGS. 6A-6D depict exemplary marketing content displayed within an application on a mobile device, according to an exemplary embodiment of the invention;

FIG. 7 depicts an illustrative flow for routing and distributing marketing content, according to an exemplary embodiment;

FIG. 8 depicts data or information that may be tagged to marketing content, according to an exemplary embodiment;

FIG. 9 depicts an illustrative flowchart of a method for processing, distributing and displaying marketing content according to an exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. The following description is intended to convey a thorough understanding of the embodiments described by providing a number of specific embodiments and details using location and time data, among other data, to send marketing content to the individuals and identify individual interests. It should be appreciated that the following detailed descriptions are exemplary and explanatory only and are not restrictive.

As used herein, the term “marketing content” is interpreted broadly to include any type of information that a sponsor or service provider may elect to send to a mobile device, a mobile unit, a stationary device, or an individual. Thus, marketing content can include, but is not limited to, offers for goods or services, incentives, coupons, requests for charitable donations, requests for information, general information not associated with an offer or request, etc. The marketing content is capable of being updated based on geography and/or time of display, and is therefore, preferably, in a digital format.

Likewise, the term “mobile device” is interpreted broadly to include any mobile vehicle unit or mobile device (such as a mobile phone or tablet) that is capable of displaying marketing content on a digital display.

The description below describes modules that may include one or more servers, databases, subsystems and other components. As used herein, the term “module” may be understood to refer to non-transitory executable software, firmware, hardware, and/or various combinations thereof. Modules, however, are not to be interpreted as software that is not implemented on hardware, firmware, or recorded on a tangible processor readable recordable storage medium (i.e., modules are not software per se). The modules are exemplary. The modules may be combined, integrated, separated, and/or duplicated to support various applications and may be centralized or distributed. A function described herein as being performed at a particular module may be performed at one or more other modules and/or by one or more other devices instead of or in addition to the function performed at the particular module. The modules may be implemented across multiple devices and/or other components local or remote to one another. The devices and components that comprise one module may or may not be distinct from the devices and components that comprise other modules.

An embodiment of the system provides the ability to present advertisements in realtime or near realtime based on the particular location of the advertisement or time of display and also allows sponsors to push the same or a similar advertisement/incentive to nearby potential customers.

Moreover, this system improves the ability to target-market potential customers of goods or services and maximizes advertisement exposure and ad visits. Targeted marketing aims to simultaneously reduce the cost of, and improve the response to, marketing campaigns by delivering marketing content to recipients who am most likely to be receptive to that content. Cost is reduced by limiting the distribution of the content and response is improved by delivering the content to these recipients most likely to respond.

Entities that employ targeted marketing face various challenges including the cost-effectiveness in identifying potential customers most likely to be differentially more receptive to the marketing content; getting those potential customers to pay attention to the marketing content; identifying the location where the marketing content should be sent to reach those individuals; and identifying the time when individuals are most likely to be receptive to the marketing content. Responding to these challenges requires the acquisition and processing of information associated with receptiveness, realtime location of individuals, and the temporal nature of the marketing content.

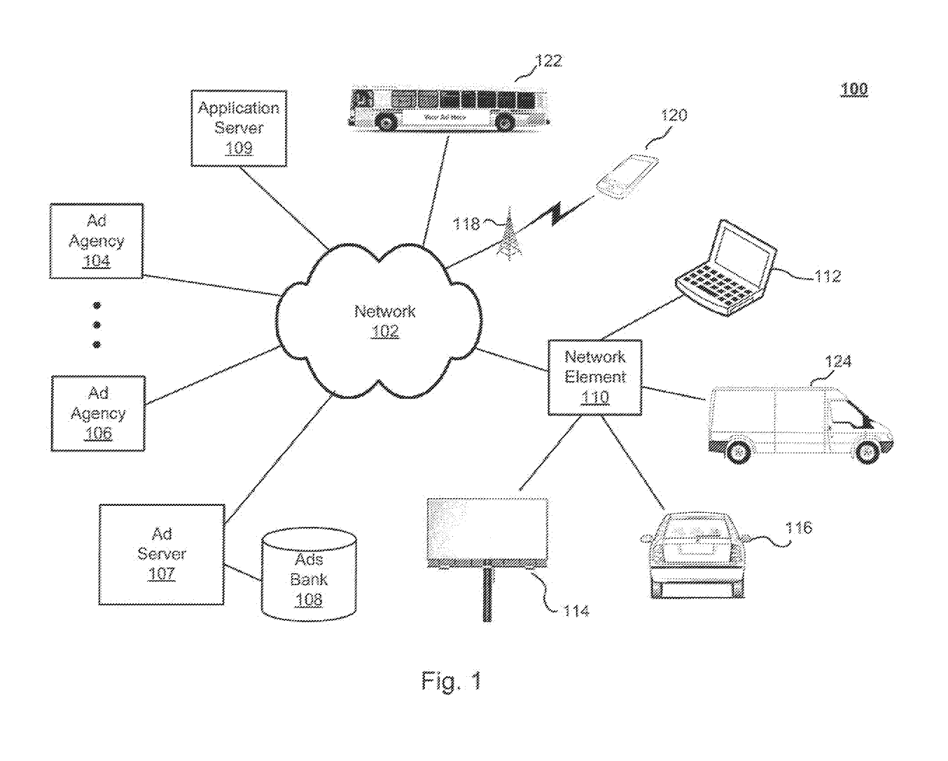

Referring to FIG. 1, a schematic diagram of a system 100 for delivering marketing content to mobile or even stationary devices, according to an exemplary embodiment. As illustrated, network 102 may be communicatively coupled with one or more devices, servers, or agents, including ad agency 104, ad server 107, ads bank 108, application server 109, network element 110, or wireless transceiver 118. Other devices may be communicatively coupled directly with network 102 or via one or more intermediary devices, such as transceiver 118 or network element 110. Wireless device 120 and network client 112 may be communicatively coupled directly with network 102 or via transceiver 118. Other various components may also be communicatively coupled with the network 102 or network element 110, such as vehicles 116, 122, 124, or display 114. Vehicles may include a personal automobile 116, bus 122, van 124, or any other vehicular device including, but not limited, to, semi-trucks, city transit buses, subway cars, trolley cars, construction vehicles, etc. Display 114 may be a non-mobile display such an a billboard, sign, advertising board, poster, placard, etc.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support, an Internet networks a wireless communication network, a cellular network, Bluetooth, or the like, or any combination thereof. Network 102 may further include one, or any number of the exemplary types of networks mentioned above operating as a stand-alone network, or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a broadcaster's network, a cellular network, corporate networks, or home networks.

Network element 110 may transmit and receive data to and from network 102. The data may be transmitted and received utilizing a standard telecommunications protocol or a standard networking protocol. For example, one embodiment may utilize Session Initiation Protocol (“SIP”). In other embodiments, the data may be transmitted or received utilizing other Voice Over IP (“VoIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems. Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection. A number of different types of signals may be transmitted via network 102 including, but not limited to, signals indicative of information content, such as a video signal, application-specific data, trigger information and/or marketing content.

Transceiver 118 may be a repeater, a microwave antenna, a cellular tower, or another network access device capable of providing connectivity between different network mediums. Transceiver 118 may be capable of sending or receiving signals via a mobile network, a paging network, a cellular network, a satellite network or a radio network. Transceiver 118 may provide connectivity to one or more wired networks and may be capable of receiving signals on one medium such as a wired network, and transmitting the received signals on a second medium, such as a wireless network.

Mobile device 120 may be a mobile communications device, a smartphone, a tablet computer, a wearable computer such as in the form of a wrist watch or glasses, a home phone, a cellular phone, a mobile phone, a satellite phone, a personal digital assistant (“PDA”), a computer, a handheld MP3 player, a handheld multimedia device, a personal media player, a gaming device, a mobile television, or other devices capable of communicating directly with network 102 or via transceiver 118.

Network client 112 may be a desktop computer, a laptop computer, a tablet, a server, a personal digital assistant, or other computer capable of sending or receiving network signals. Network client 112 may use a wired or wireless connection. It should also be appreciated that the network client 112 may be a portable electronic device capable of being transported. Such a device may transmit or receive signals and store information in transit, and in the event it is transported, the portable electronic device may still operate using the data (e.g., digital image, marketing content, etc.) it stored. Additional network clients may be located in vehicles 122, 124, 116 or in display 114.

According to one or more embodiments, network client 112, wireless device 120, and vehicles 122, 124, 116 using a wireless connection may authenticate with a network using Wired Equivalent Privacy (“WEP”), Wi-Fi Protected Access (“WPA”), or other wireless network security standards. Network client 112, wireless device 120, and vehicles 122, 124, 116 may connect to network 102 and communicate with other network elements, servers or agencies using WiFi, 3G, 4G, bluetooth, and may also contain a Global Positioning Satellite (GPS) receiver/processor. The location of the mobile unit or mobile device may be determined using the methods and systems described in U.S. Pat. No. 8,391,886, assigned to Cellco Partnership d/b/a Verizon Witless, and entitled “Systems and Methods for Providing Mobile Handset Position to Software Applications,” incorporated herein by reference in its entirety.

Multiple ad agencies, such as ad agencies 104, 106, may communicate with ad server 107 via network 102. Ad agencies 104, 106 may provide marketing content to ad server 107 and the marketing content may be stored in ads bank 108. The ad server 10 may be maintained by Verizon Wireless, for example, and may deliver the marketing content to various mobile units or mobile devices, including network client 112, wireless device 120, and vehicles 122, 124, 116, (collectively hereinafter “mobile unit 124” or “mobile device 120”) or display 114. The marketing content may be categorized or assigned criteria by ad agencies 104, 106 or by ad server 107 based on type of marketing content (such as apparel, food, service, for example), value (such as $ or % off), business(es) associated with the marketing content and the corresponding contact information of the business, including address, telephone number, and website, and other information relevant to the business, such as hours of operation. The marketing content may be further categorized or assigned criteria based on preferred location of display, time of display, proximity to known geographical locations of, for example, businesses, parks, institutions, or proximity to other mobile units 124, mobile devices 120, or even displays 114. The marketing content may also be categorized or assigned criteria according to weather, news, or current events. For example, marketing content associated with an ice cream shop may be categorized according to the name, address, telephone number, hours of operation, and website of the ice cream shop, an incentive category such as “Less than $1 off,” or “Less than $1 off and more than 10% off,” and further assigned criteria such as to be displayed within five miles of the ice cream shop, during the hours of 11:00 AM-7:00 PM, and when the weather is warmer than 95 deg. Fahrenheit. As can be seen, the categories and criteria may specify conditions under which the marketing content is to be displayed, and can be displayed when one or more of the conditions (or a predetermined set of the conditions) are satisfied. For example, marketing content for the ice cream shop may have criteria allowing it to be displayed and/or distributed when the temperature is warmer than 100 deg Fahrenheit, regardless of the time of day. Accordingly, one or more categories or criteria can e set to trump other categories or criteria. The marketing content may have one or multiple categories or criteria and the categories and criteria may be tagged to the marketing content and stored in ads bank 108 or another database.

It should be appreciated that the system 100 of FIG. 1 may be implemented in a variety of ways. Architecture 100 may be implemented as a hardware component (e.g., as a module) within a network element or network box. It should also be appreciated that architecture 100 may be implemented computer executable software (e.g., on a tangible computer-readable medium). Although depicted as a single architecture, module functionality of architecture 100 may be located on a single device or distributed across a plurality of devices including one or more centralized servers and one or more mobile units or end user devices.

While depicted as various servers, components, elements, modules, or devices, it should be appreciated that embodiments may be constructed in software or hardware, as a separate or stand-alone device, or as part of an integrated system, device, or tool.

Additionally, it should also be appreciated that system support and updating the various components of the system, may be achieved. For example, a system administrator may have access to one or more of the components of the system, network, components, elements, or device. It should also be appreciated that the one or more servers, components, elements, or devices of the system may not be limited to physical components. These components may be computer-implemented software-based, virtual, etc. Moreover, the various servers, components, elements, or devices may be customized to perform one or more additional features and functionalities. Such features and functionalities may be provided via deployment, transmitting or installing software or hardware.

It should also be appreciated that each of the communications devices, servers, modules, or network elements may include one or more processors. One or more data storage systems (e.g., databases) may also be coupled to each of the devices or servers of the system. In one embodiment, the one or more data storage systems, such as ads bank 108, may store relevant information for each of the servers and system components. It should also be appreciated that software may be implemented in one or more computer processors, modules, network components, services, devices, or other similar systems.

It should be appreciated that the contents of any of these one or more data storage systems may be combined into fewer or greater numbers of data storage systems and may be stored on one or more data storage systems or servers. Furthermore, the data storage systems may be local, remote, or a combination thereof to client systems, servers, or other system components. In another embodiment, information stored in the databases may be useful in providing additional personalizations and customizations of the marketing content.

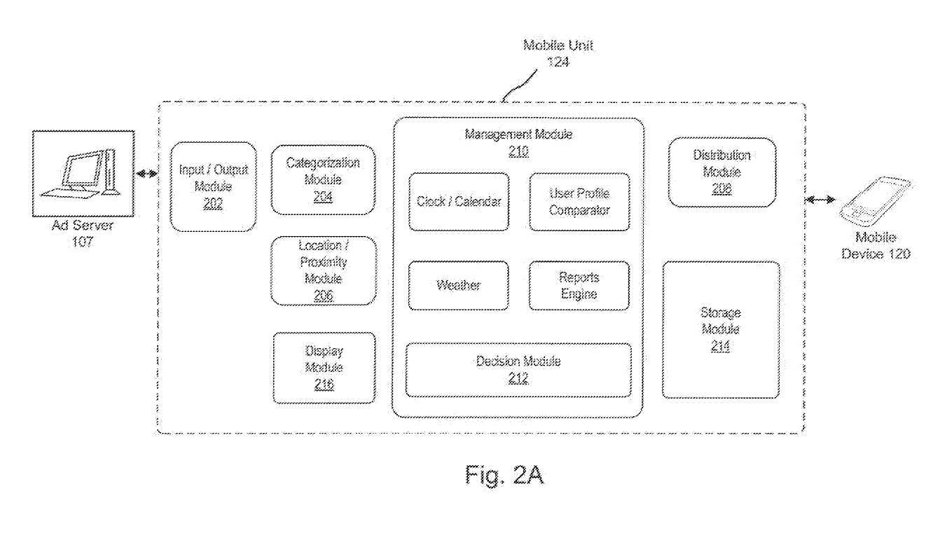

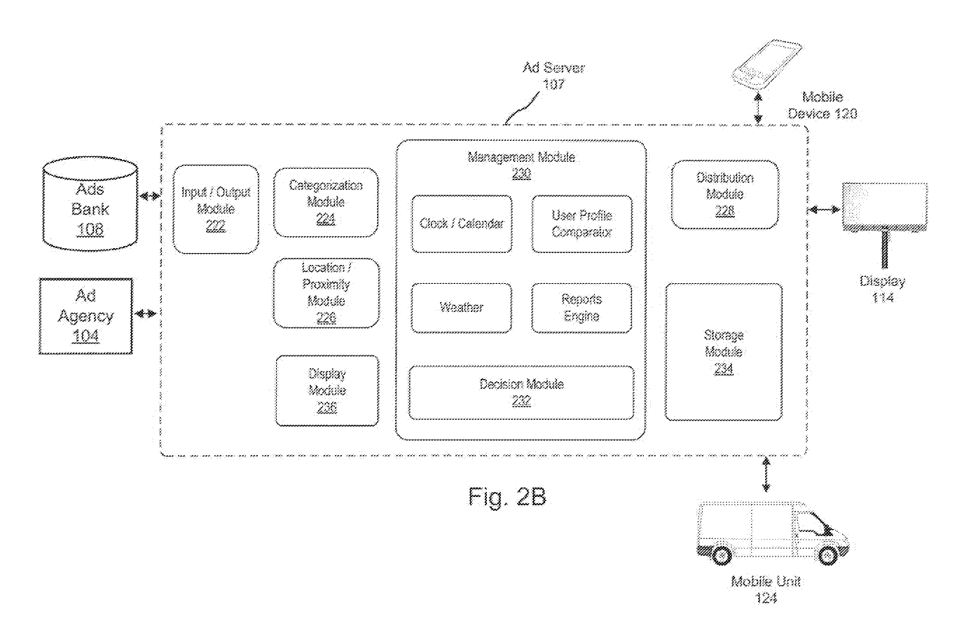

Referring to FIG. 2A, a block diagram of exemplary modules within a mobile unit 124 for processing, managing, displaying, and delivering marketing content is shown, according to an exemplary embodiment. The exemplary modules in FIG. 2A may also be found in ad server 107, as depicted in FIG. 2B, which may perform many functions similar to mobile unit 124. Ad server 107 may send marketing contest, updated marketing content, and/or other data or instructions to the input/output module 202 of mobile unit 124 via network 102. The marketing content may be stored in storage module 214 for later display or distribution. The marketing content in storage module 214 may also be updated based on instructions from ad server 107, and other data or instructions from ad server may also be stored in storage module 214.

Categorization module 204 may aid in organization, distribution, and/or display of the marketing content. For example, categorization module 204 may assign categories and criteria to the marketing content, update the assigned categories or criteria, and/or organize the marketing content according to the assigned categories and criteria.

Location/Proximity module 206 may comprise a WiFi, 3G, 4G, or Bluetooth component, a GPS receiver/processor, and/or other components to track the location of the mobile unit and/or nearby mobile devices to yield location data. The respective location of the mobile unit and/or mobile devices may be compared to obtain proximity data. The location data and/or proximity data may be used by decision module 212 in the determination of whether to display the marketing content and/or distribute the marketing content. Location/Proximity module 206 may also compare the location of mobile unit 124 to displays 114, such as billboards along the road or marketing displays at a particular business, to yield additional location or proximity data. Proximity data may comprise a radius around mobile unit 124 or display 114, such as a radius of 200′, 100′, 50′, or 10′. Proximity may be dependent on multiple factors including specifics of the ad providing unit (e.g., type, size, location, speed of the mobile unit/display) and other nearby ad providing units, of the ad receiving unit (e.g., speed/direction of travel of the mobile device, specifics of the mobile device user), and of environmental conditions (e.g., rain, high smog day). Other mobile units 124 and/or mobile devices 120 within this radius may be considered “proximate” to mobile unit 124 and/or display 114 around which the radius is defined. Any distance or radius may be used, such as from 3′ to 30 miles, for example, depending on factors similar to the above. Displaying particular marketing content on mobile unit 124, and/or display 124 while in the area of a mobile device 120, another mobile unit 124, and/or display 114, which may also display the same, coordinated, or complementary marketing content (or related content), allows a sponsor of the marketing content to temporarily fill the marketing scene at that particular location as well as locations near particular displays. “Near” may be considered within a viewing distance of each other, such as a user of mobile device 120 being within a viewing distance of mobile unit 124, or may pertain to a radius around a location of interest, such as a location of a particular business, or a location of mobile unit 124, display 114, or mobile device 120. Alternatively, “near” may be considered within a certain number of miles (e.g. 5 or fewer) or a certain number of blocks (e.g. 10 or fewer). Viewers are much more likely to take notice of marketing content when it is displayed in multiple locations that are proximate to each other, displayed at the same time or in succession, or that are complementary to or coordinated with other nearby ads. For example, mobile unit 124 may display marketing content for a particular restaurant when passing by a billboard that is also displaying marketing content for that particular restaurant, and while driving near mobile device 120 to which the same or similar marketing content may be “pushed.”According to another example, mobile unit 124 may display marketing content for the particular restaurant when passing by the restaurant, which, may itself have the same or similar marketing content displayed. Accordingly, viewers that see the marketing content multiple times—on mobile unit 124, on their mobile device 120, and/or on a display 114, arc more likely to remember the marketing content.

Display module 216 may display marketing content on the mobile unit 124 when the determination is made by decision module 212 that the marketing content should, be displayed. Display module 216 may comprise various components for displaying the marketing content, as is well known in the art. For example, the marketing content may be displayed on one or more of a plasma display panel (PDP), liquid crystal display (LCD), thin film, transistor (TFTLCD), super LCD, light emitting diode (LED), organic LED (OLED), active matrix OLED (AMOLED), LED-backlit LCD, super AMOLED, or a retina display. The marketing content may also be displayed on a flexible display using flexible screen technology such as flexible electronic paper (e-paper), organic thin film transistors (OTFT), flexible OLEDs, or flexible AMOLEDs.

The marketing content may be displayed as a video, animation, slide show, a single image, and/or a collection of images, for example. For example, specific slides or frames of marketing content may be assigned to be displayed in a predetermined area or split into sub-locations within an area. A sponsor for particular marketing content may cover a 1/2 mile radius, for example, and the displayed marketing content within that radius may change each block in that 1/2 mile radius. Display module 216 may transition from marketing content to marketing content according to a predetermined transition scheme that may be tagged to a file containing the marketing content or as determined by the decision module 212. For example, the transition may involve a cut from one marketing content file to the next, or a mix, dissolve, crossfade, fade, wipe, and/or other various digital effects such as color replacement pixelization, animated effects, focus drops, and/or lighting effects. The marketing content may also be presented in audio format, either with or without a corresponding video feed. How the marketing content is presented (format, transitions) may depend on the location of the display. For example, urban locations may be more amenable to marketing content having or comprising audio.

Mobile unit 124 may also comprise a management module 210 which manages the display and/or distribution of marketing content. Management module 210 may utilize a clock, calendar, weather sensors, forecast reports, a user profile comparator, and/or a reports engine, for example. A primary component of the management module 210 may include decision module 212. The decision module 212 may determine whether to display marketing content, whether to distribute marketing content, what marketing content to display/distribute, when to display/distribute, how to display, how long to display, and/or which groups, individuals, or businesses to display the marketing content to based on proximity to those groups, individuals, or businesses. The decision module 212 may take into account variables such as the categorizations and criteria of the marketing content, location and/or proximity of the mobile unit 124 to other mobile units, mobile devices 120, or displays 114, the time of day, day of the week, month, or year, and the current, or forecasted weather, for example.

Importantly, the decision module may take into account user profiles and/or user settings before distributing marketing content to various mobile devices 120, as discussed in more detail below. The distribution module 208 of mobile unit 124 may distribute marketing content via network 201 from the mobile unit 124 to various mobile devices 120 or displays 114, such as nearby mobile devices 120 or displays 114. Ad server 107 may also distribute marketing content via network 102 directly to mobile units 124, mobile devices 120, and/or displays 114 via network 102, using similar modules to those explained above, and as shown in FIG. 2B. The distribution module 208 of mobile unit 124 may instruct ad server 107 to distribute marketing content to particular mobile devices 120 or displays 114 based on local information known to mobile unit 124, such as location data, proximity data, weather data, for example. A number of mobile devices 120 may be near mobile unit 124 or display 114, and which marketing content is actually distributed to mobile unit 124, display 114, or mobile device 120, may be in conflict if display of the marketing content takes into account proximity data for the various mobile devices 120. Accordingly, the system may take into account the various users' preferences, and may weigh the users' preferences according to their degree of completeness. For example, users with many explicit preferences, i.e., preferences expressly provided by the user, may trump users with only implicit preferences and few or no explicit preferences. Further, users that have previously “acted upon” received marketing content may be weighed more heavily when determining which marketing content to deliver in the above situation.

The user settings may include a “do not track” (or, alternatively, an “opt-in”) option that may be enabled by the user via an application in mobile device 120, for example. Such a setting would prevent (or allow) a location/proximity module from collecting and/or using data relating to location or proximity of mobile device 120. Note that to the extent the various embodiments herein collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

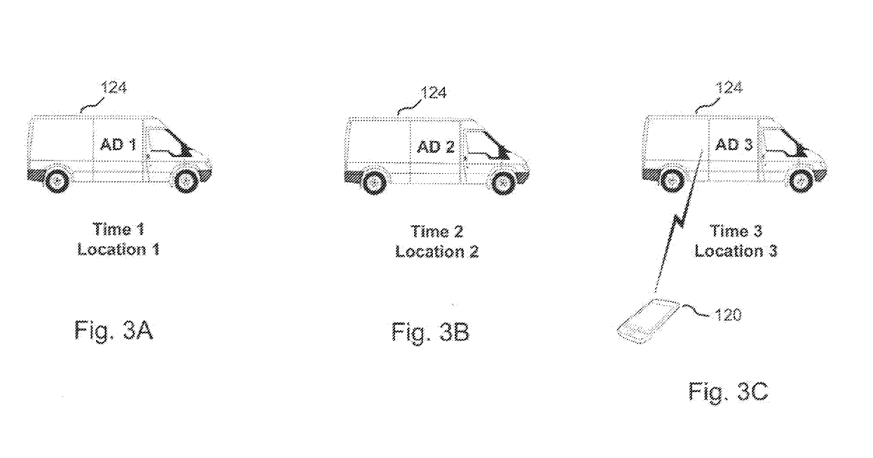

Referring to FIG. 3, mobile unit 124 may display a first item of marketing content (termed “AD 1” in FIG. 3) at time 1 and location 1. A second item of marketing content (“AD 2”) may be displayed at time 2 and location 2, and a third item of marketing content (“AD 3”) may be displayed at time 3 and location 3. For example, a mobile unit traveling through or stationed at Newark Airport around 7:00 AM may display advertisements relating to hotels, car rentals, tourism, nearby restaurants open for breakfast, etc. The marketing content may relate to current specials sponsored by the hotels, car rental companies, or restaurants, for example. Then, as the van heads to Manhattan around 12:00 PM, mobile unit 124 may display marketing content for a local Japanese restaurant that has a current special on sushi, or a local business merely seeking to advertise its name. A few minutes later, around 12:15 PM, as the mobile unit travels near the theater district and Times Square, it may display marketing content for a Broadway musical that will be showing that evening. For example, a picture of Les Miserables may be displayed with adjacent text indicating the showtime, date, address, an incentive such as “$25 Off,” and a corresponding code (e.g., “#43254”) that may be used when purchasing tickets for the musical. The code may be unique to the mobile unit 124 or may be more general but preferably may be used by the management module 210, ad server 107, or ad agency 104 when determining the effectiveness of the displayed or distributed marketing content. The realtime nature of the marketing content may involve displaying the showtimes or even the number of seats that are still available for purchase.

Alternatively, AD 2 and/or AD 3 may be substantially similar to AD 1, but have minor modifications. For example, AD 1 may advertise for a business having a several distinct locations. AD 1 may contain content referring to a particular location of such a business and/or a particular incentive or discount for that location or additional locations. Then at time 2 and location 2, AD 2 may still advertise for the same business, but now contain content referring to another location of that business and/or a different incentive or discount, and may include a different discount code. AD 3, displayed at time 3 and location 3, may contain similar changes to the marketing content. Other changes to the marketing content may include the particular good/service advertised, based on what is popular at a particular location. Such changes to the marketing content may be effective for businesses having a regional or national presence, such as chain stores, and would even be beneficial for franchises operating under a similar business model but at different locations.

As shown in FIG. 3C, mobile unit 124 may distribute via network 102 marketing content to nearby mobile devices 120, the users of which may have viewed the marketing content on mobile unit 124. Distribution of the marketing content may be centralized via network 102 and may be sent directly from mobile unit 124, or mobile unit may inform ad server 10 of the location of mobile device 120 and/or instruct ad server 107 to send the marketing content to mobile device 120 via network 102. As discussed above, the location/proximity module 206 may determine the proximity of nearby mobile devices 120, other mobile units 124, or displays 114, using WiFi, 3G, 4G, bluetooth, or GPS signals, for example. Users within 200′, 100′, 50′, or 10′, for example, of a mobile unit 124 or display 114, may receive the same or similar marketing content on their mobile devices 120 that is being displayed on mobile unit 124 or display 114. The marketing content distributed to mobile devices 120 may be complementary to or coordinated with the marketing content displayed on mobile unit 124, in that the distributed marketing content may be generally the same but have additional (e.g., more specific) content that may entice the user of mobile device 120. For example, mobile unit 124 may display marketing content for a sporting goods store, and simultaneously, or in sequence, distribute complementary marketing content to nearby mobile devices, which may be in the form of tailored marketing content, tailored to particular users of nearby mobile devices. The complementary or tailored marketing content for the sporting goods store may include an incentive to purchase basketball or baseball equipment, delivered to nearby mobile devices operated by male users, or an incentive to purchase yoga apparel, delivered to nearby mobile devices operated by female users. Alternatively, coordinated marketing content may be distributed to nearby mobile devices, and such coordinated marketing content may advertise another, but related, business. For example, mobile devices near mobile unit 124 (which may be displaying marketing content for the sporting goods store discussed above) may receive marketing content for a nearby fitness center, which may conduct yoga classes. Such marketing content may be considered coordinated because the respective marketing content (on mobile unit 124 and distributed to mobile device 120) is from two different entities, yet pertains to related subject matter (i.e., fitness), or may be complementary and coordinated in that the marketing content delivered to nearby mobile device 120 may refer to yoga apparel on sale at the sporting goods store, in addition to advertising the fitness center's yoga classes. Further, such marketing content may provide a conditional incentive that may be considered coordinated, and/or complimentary. For example, the sporting goods store may offer a discount of $20 off yoga apparel if a person signs up for a yoga class at the fitness center. Which complementary/coordinated marketing content is selected to be distributed may depend on user preferences of each mobile device 120. And whether the marketing content is actually distributed may also depend on other criteria, as discussed further below. In some embodiments, the complementary or coordinated nature of the marketing content may prevent competition between competing or competitor ads. For example, the sporting goods store and fitness center mentioned above may be targeting the same type of consumer, and may be considered to be competing for “ad views” or “ad visits” by that particular type of consumer. However, with coordinated and/or complementary marketing content, the two different entities can market mom effectively to the same consumer. Hence, rather than being considered competitors in the marketing scene, the sporting goods store and fitness center, for example, may be considered beneficial to each other since a consumer may need sporting apparel in order to work out at the fitness center, and such a consumer may be more likely to sign up at the fitness center if he/she is presented with an incentive or advertisement for sporting apparel as well as an incentive or advertisement for the fitness center.

It should be appreciated that mobile unit 124 may be an individual consumer's vehicle. Drivers are often surrounded by other consumer's vehicles, whether it be in slow traffic or while waiting at a traffic light. Vehicles often have bumper stickers touting their children's “honor roll” status, or even trademarks and slogans of various companies, sports teams, or colleges. Implementing a display on individual consumer vehicles has the potential to maximize advertisement exposure and also provide an additional source of income to the individual consumer in the form of advertising revenue. A display on this type of mobile unit 124 may take the form of any of the displays mentioned above, and in particular flexible electronic paper (e-paper), organic thin film transistors (OTFT), flexible OLEDs, or flexible AMOLEDs. Marketing content displayed on this and other types of mobile units 124 may be non-distracting to other drivers. For example, the marketing content may be limited to being displayed when mobile unit 124 is stopped or traveling at very low speeds, such as less than 5 mph. Then when mobile unit 124 begins to travel again, the display may go blank until mobile unit 124 stops again. Accordingly, the rate of movement of mobile unit 124 may be taken into account when assigning criteria to marketing content and when displaying the marketing content on mobile unit 124.

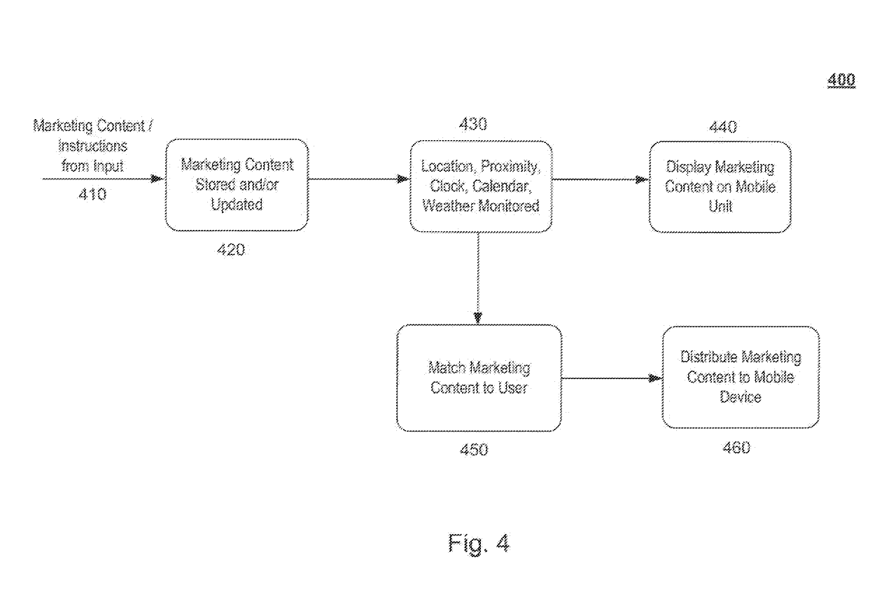

Referring to FIG. 4, an illustrative flow for processing, displaying, and delivering marketing content is shown, according to an exemplary embodiment. At 410, marketing content, instructions, and/or other data may be received at input/output module 202 from ad server 207. At 420, the mobile unit 124 may store the marketing content, instructions, and/or other data within storage module 214, or may update the marketing content, instructions, or other data already stored in storage module 214. At 430, or concurrently with the reception and/or display and distribution of marketing content, mobile unit 124 may monitor the location of mobile unit 124, its proximity to other mobile units 124, mobile devices 120, or displays 114, and may also monitor the clock, calendar, and current or forecasted weather.

At 450, marketing content may be matched to a particular user using the user profile comparator of management module 210. A user of mobile device 120 may agree to receive marketing content on their mobile device 120. Consent to receive marketing content may be given before the user views the displayed marketing content, or at the time of viewing. An option may be provided to the user to download marketing content that was displayed within a proximity of the user for a previous predetermined amount of time or for a certain number of previously displayed ads. Fox example, the user may desire to download to mobile device 120 marketing content that was just seen while the user was walking down the street. The user may establish various settings using an application on mobile device 120 or another computing device. The application may be a third-party application, such as a social media application and distributed to mobile device 120 using application server 109. Also, the application may be a social media add-on such that it operates in conjunction with a social media application, but may be maintained by an entity other than the social media entity.

User settings established by the user within the application, or using an associated website on the Internet, may be stored on the mobile device 120, on application server 109, on ad server 107, or on mobile unit 124. For example, user settings may comprise a user profile, which may include name or username, address, email address, gender, or financial information such as preferred credit card or checking account information. The user profile may also include social media hashtags associated with the user or various demographic data such as age, ethnicity, employment status, home ownership status, income, education, or knowledge of languages, for example. User profiles may also comprise information unique to the user such as information gathered during an IP access session, such as data on previous Internet searches or URLs visited, cookies associated with the user, each of which may be pulled from mobile device 120 or another computing device of the user such as network client 112. A single IP access session may involve multiple devices either over time or at about the same time. An IP access session may be treated anonymously or non-anonymously. A system or service can address a user of mobile device 120 through the IP address associated with the IP access session without determining the user's identity. On the other hand, a service provider can combine information associated with the IP access-session, such as a user ID, with other information in its system, such as information in a customer account database, to determine the user's identity and other information relevant to the user. Other historical data of the user, such as previous or current geographical location of the mobile device 120 may also be stored, giving due regard to privacy laws and the privacy settings of the user.

Importantly, the user profile may also include the types of marketing content the user has agreed to receive or prefers to receive. For example, a particular user may only be interested in receiving marketing content for coffee, clothes, 5-star restaurants, and theatrical productions, and only when the marketing content includes an incentive greater than 15% off. Another user may prefer to receive marketing content for goods or services relating to children and also local real estate offers, but only real estate offers between $400-600 k that have recently dropped in price and within a particular geographic location or within a certain proximity to the user's current location.

Additionally, all or a portion of the marketing content displayed on mobile units 124 or displays 114, near mobile device 120 (e.g., within viewing distance of), may be distributed to mobile device 120 in an unobtrusive manner, such as being displayed in a rolling list of marketing content within an application on mobile device 120. The user may also be enabled to set up a “wishlist” within the application for desired products or services, and a corresponding price range for the desired products or services. The user profile may also retain information on previous marketing content acted upon by the user, such as coupons previously used. For example, the application may keep a record of purchases made in the store within the application or keep a history of hyperlinks selected within the application that direct the user to an Internet website where the user browses for or purchases products or services. Such “wishlist” or “historical actions” information may be taken into account by ad server 10 or mobile unit 124 before delivering marketing content to mobile device 120, or before displaying marketing content on mobile unit 124 or display 114. For example, such information may be weighted more heavily than, for example, demographic information, when determining which marketing content to distribute or display. User settings and profiles may be continuously monitored by ad server 107 and used by ad server 107 or mobile device 124 when making the determination of how to distribute and/or display particular marketing content to particular users on the go. For example, each time a user setting or profile is changed, the change may be sent in a data message to ad server 107 via network 102 and stored in a record related to the particular user. Other information relevant to a particular user may be stored in such a user record within a database at ad server 107.

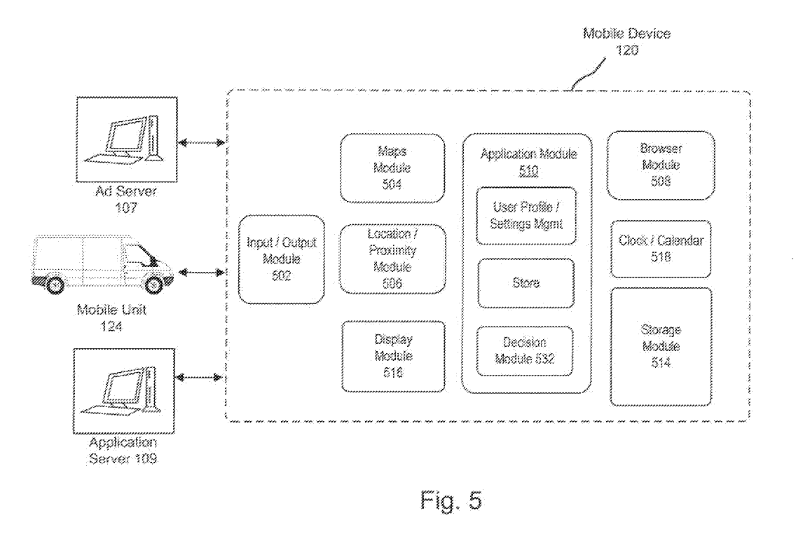

Referring to FIG. 5, a block diagram of a hardware module at a mobile device for processing, managing, and displaying marketing content according to an exemplary embodiment of the invention, is shown. Ad server 107 or mobile unit 124 may send marketing content, updated marketing content, or other data to the input/output module 502 of mobile device 120 via a network such as network 102. Similarly, application server 109 may send data, such as application data, to mobile device 120. The application data and marketing content may be stored in storage module 514 for use by mobile device 120. The marketing content in storage module 514 may also be updated based on instructions from ad server 107 or mobile unit 124. Application data may also be updated based on instructions from application server 109.

A location/proximity module 506 may comprise a WiFi, 3G, 4G, or bluetooth component, a GPS receiver/processor, or other components commonly found within modern mobile devices 120. These components may obtain location data of mobile device 120 and relay this data to application module 510.

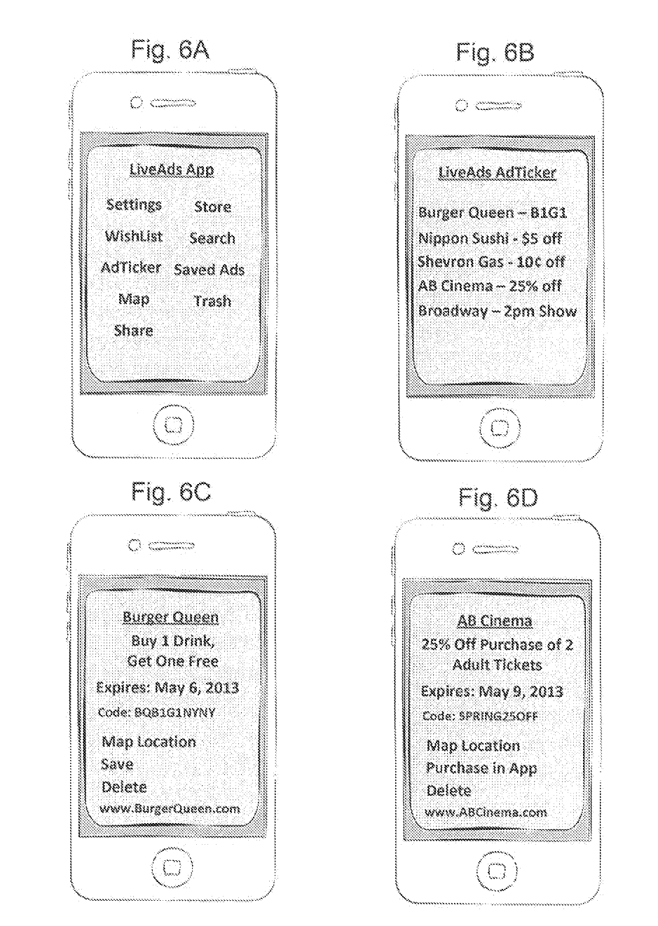

Application module 510 may run an application on mobile device 120 used for storing, displaying, and searching marketing content. Exemplary screenshots of an application, termed “LiveAds,” are shown in FIGS. 6A-6D. Application module 510 may allow a user of mobile device 120 to manage their user profile or user settings within the application. Application module 510 may also allow a user to act upon particular marketing content by allowing the user to purchase the good or service within the application itself. Alternatively, application module 510 may utilize a browser module 508 on mobile device 120 and link to a particular website. Further, application module 510 may utilize a maps module 504 on mobile device 120 to allow the user to view a map or obtain directions to a particular business location related to received marketing content. Application module 510 may retain a history of marketing content received or acted upon, a user wishlist, and may allow a user to save, search, delete, or share marketing content. Marketing content may be considered “acted upon” if the user purchased a good or service advertised in the marketing content, or if the user obtained more information on the advertised good or service by linking to a website relating to the good/service, adding the good/service to a digital shopping cart within the business's website or within the “Store” in the application, mapped the location of the business offering the good/service, or physically traveling to that location. The user may be enabled to search marketing content that has been received by mobile device 120 or marketing content that has not been received but is stored in ads bank 108. Searches may be performed based on location, keywords, or categories of marketing content. Application module 510 may also enable an “AdTicker” function which may display within the application in an unobtrusive manner all or a portion of marketing content displayed near mobile device 120 (e.g., displayed on a mobile unit 124 or display 114 within the viewing distance of a user of mobile device 120) such as in a rolling list of marketing content within the application.

In a further exemplary embodiment, location/proximity module 506 may determine that mobile device 120 is about to lose reception to network 102. For example, location proximity module 506 may determine that mobile device 120 is in an airport, and may further determine that a user of mobile device 120 is about to board an airplane. Based on this determination, various marketing content may be selected to be displayed on mobile device 120 once mobile device 120 loses access to network 102. Such selection of marketing content may be made by a decision module on ad server 107 or mobile unit 124, or on mobile device 120 itself if the marketing content is already within storage module 514 of mobile device 120. Once the mobile device 120 loses access to network 102, the marketing content may be displayed at predetermined times or intervals, and time may be determined by clock/calendar 518 on mobile device 120. For example, marketing content relevant to flying may be selected and “queued” up on mobile device 120 prior to mobile device 120 losing access to network 102, such that the marketing content may be displayed even though mobile device 120 does not have access to network 102. The marketing content in this airport example may be relevant to travel, or flying, such as advertising related to a “Sky Mall,” or may include incentives to purchase a book to read or other media to view that may have been previously “queued” up to mobile device 120. The amount of storage that may be reserved for such “queued” content may be determined by the user in the user settings on mobile device 120. The type of “queued” content may also be determined by user of mobile device 120, such as by placing particular content or categories of content, in the user's “wishlist.”

Referring to FIGS. 6A-6D, screenshots of an exemplary “LiveAds” application are shown, according to an exemplary embodiment of the invention. The application operated on mobile device 120 may enable various functionality, such as allowing a user to adjust user settings or update a user profile, set up a wishlist, view ads in an “AdTicker,” map the user's location or proximity to various businesses associated with the marketing content, share marketing content or other information from the mobile device 120, purchase goods or services in a store within the application, search information from within the application, and save or delete marketing content received at mobile device 120.

The user may establish various settings within the application on mobile device 120 or another computing device such as a home computer. The user settings may comprise a user profile, which may include name or username, address, email address, gender, or financial information such as preferred credit card or checking account information. The user profile may also include social media hashtags associated with the user or various demographic data such as age, ethnicity, employment status, home ownership status, income, education, or knowledge of languages, for example. User profiles may also comprise information unique to the user such as information from previous Internet searches or URLs visited, cookies associated with the user, each of which may be pulled from mobile device 120 or another computing device of the user. Under “Settings,” the user may be able to delete cached information such as previous Internet searches, URLs visited, stored cookies, mapped locations, etc.

The user may set up a wishlist of desired goods or services that the user wishes to learn more about or to purchase. Within the wishlist, a corresponding price range for the desired products or services may be entered. Alternatively, the wishlist may simply be a list of marketing content indicated by the user to be a “favorite.”

The application may also enable an AdTicker function, which may cause to be displayed within the application all marketing content relevant to the current location of mobile device 120. For example, all marketing content displayed within a viewing distance of mobile device 120 may be displayed in the AdTicker in a rolling list of marketing content within the application. The viewing distance may be a predetermined radius from mobile device 120 set by ad server 10 or the user of mobile device 120. Alternatively, the AdTicker may display marketing content that is relevant to the current location of mobile device 120 and that was not displayed within a viewing distance of mobile device 120. Marketing content relevant to the current location of mobile device 120 may comprise all marketing content within ads bank 108 that pertains to businesses within 10 feet to 100 miles of mobile device 120, for example. All such marketing content within this exemplary range may be further limited based on the user settings or wishlist. For example, a user may limit the marketing content displayed in the AdTicker to restaurants within 1 mile of the user's current location, and further limit the displayed marketing content to only those restaurants serving breakfast. The AdTicker may be enabled to automatically display such results based on the rate at which the user is traveling (such as riding in a car at 45 miles per hour (mph), or walking at 3 mph) and also based on time, such as time of day. For example, if the mobile device 120 is moving at an average rate of 3 mph along a city street at 8:30 AM, based on location data from the location/proximity module 506 and time data yielded from clock/calendar 518, an assumption can be made that the user is either walking or in heavy traffic. Accordingly, the displayed marketing content may be “zoomed” to one quarter mile and limited to restaurants offering breakfast or coffee. Alternatively, if the mobile device 120 is traveling at 55 mph along a highway at 11:30 PM, the displayed marketing content may be automatically “zoomed” to 10 miles and limited to businesses that are still open such as late-night restaurants or gas stations.

An exemplary AdTicker displaying various marketing content is shown in FIG. 6B. A user may select one item of marketing content by, for example, tapping the screen of mobile device 120. Doing so will yield further information on the particular item of marketing content (FIGS. 6C-6D), such as name of the business establishment, an offered incentive, expiration date, code for the offered incentive, and options to map the location of the business establishment, save or delete the particular item of marketing content, link to a website of the business, or an option to purchase the particular good/service advertised within the particular item of marketing content (FIG. 6D).

The real-time, location-based functionality described above with respect to the AdTicker may also be utilized within the “Map” feature of the application. According to an exemplary embodiment, marketing content within 1 mile of the user's current location is updated within the map and the AdTicker as the user travels. In addition to location, the actual marketing content that is displayed may also be based on a rate of travel of mobile user device 120, user settings, and time, such as time of day, week, or year, as described above.

The application may also enable a user to share information, such as marketing content stored or displayed within the application, to others. For example, after tapping “Share,” a user may be given the option to email, text message, print, or post one or more particular items of marketing content to a social networking website.

Another useful feature that may be offered within the application is a store for purchasing a particular good or service advertised within marketing content received on mobile device 120. After tapping “Store,” for example, the user may be presented with a digital shopping cart into which the user previously added particular goods or services advertised within the marketing content. A good or service may have been added to the shopping cart after clinking on the item of marketing content within the AdTicker. For example, as shown in FIG. 6D, a user may be presented with the option to “Purchase in App” the good/service advertised in that item of marketing content. Additionally, the “Store” feature may be handled by a third party such that purchasing transactions are carried out by the user with a third party.

The application may also enable a user to search information such as marketing content stored or displayed within the application, view “saved ads” or deleted ads, such as marketing content that a user selected to save or delete after viewing. The application may provide other functionalities as would be understood by one of ordinary skill in the art.

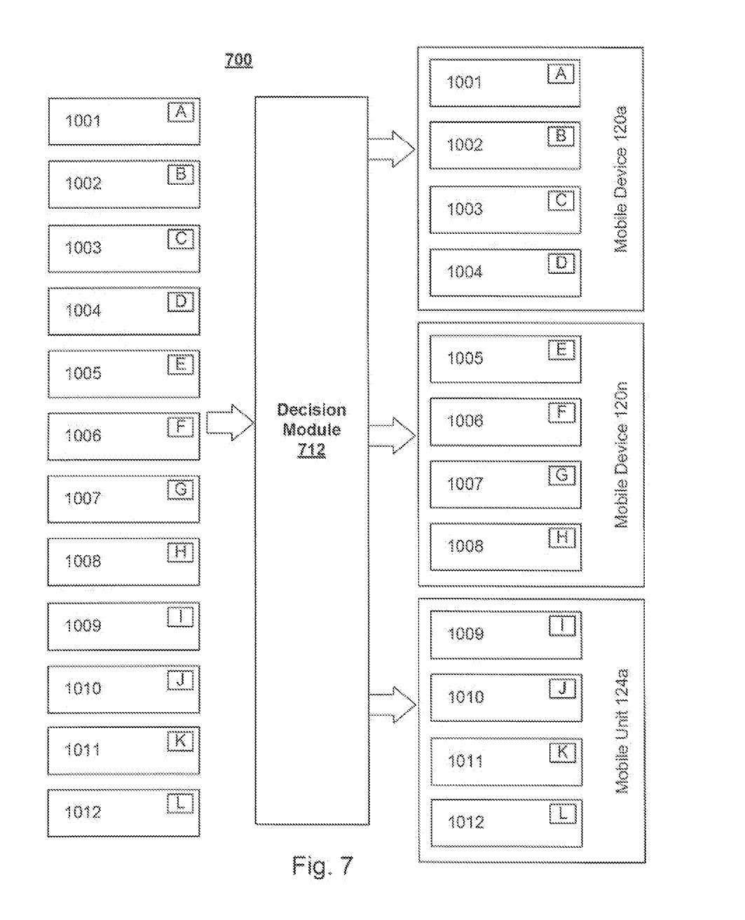

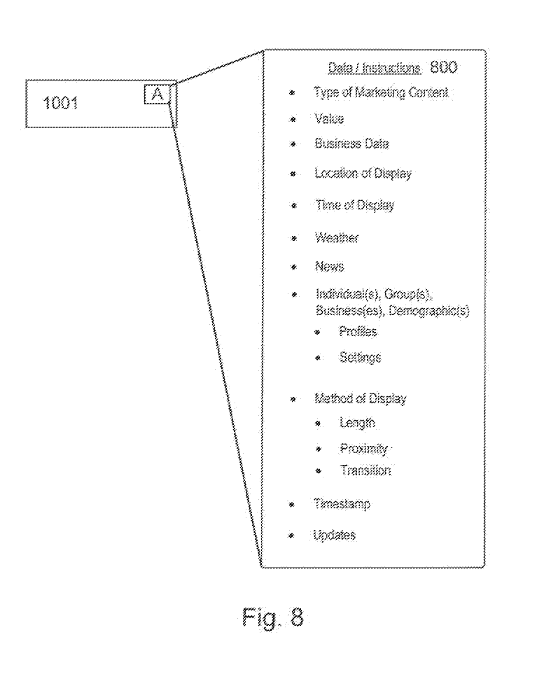

Referring to FIGS. 7-8, an exemplary decision module 712 is shown, such as decision module 212 within mobile unit 124 (FIG. 2A) or a corresponding decision module 232 within ad server 107 (FIG. 2B). Elements 1001-1012 represent items of marketing content that decision module 712 may distribute to mobile devices 120a-120n or mobile unit 124n. Decision module 712 may also distribute marketing content to various mobile mats 124 or displays 114. Labels “A”-“L” on elements 1001-1012 may represent data or instructions 800 (FIG. 8) tagged to the particular items of marketing content. Such data 800 may be in the form of metadata and may comprise categories and/or criteria assigned to individual items of marketing content 1001-1012.

Data 800 tagged to the particular items of marketing content may be based on type of marketing content (such as apparel, food, service, for example), value (such as $ or % off), business(es) associated with the marketing content and the corresponding contact information of the business, including address, telephone number, and website, and other information relevant to the business, such as hours of operation. Data 800 may also comprise various criteria such as expiration of the marketing content; preferred location of display, time of display, proximity to known geographical locations of, for example, businesses, parks, institutions, or proximity to other mobile units 124, mobile devices 120, or displays 114; current or forecasted weather, news, or current events. Such data 800 tagged to the particular items of marketing content may also be based on individuals, groups, businesses, or demographics that may be more receptive to the marketing content, preferred time to display/distribute, preferred method of display, including how long to display, preferred relative proximity of a display to said individuals, groups, or businesses, and the method of display including the length of display and how the marketing content transitions from one item of marketing content to another.

Data 800 may also comprise a timestamp indicating when the item of marketing content was last updated, displayed, and/or distributed. The timestamp may be used when generating reports, using the reports engine on the management module 210 (FIG. 2). For example, reports may be prepared by the reports engine and may include the marketing content displayed, delivered, the corresponding timestamp information, whether the marketing content was “acted upon,” saved, deleted, viewed, etc.

The decision module 712 may take into account all or a portion of data 800 when making the determination of whether to display or distribute the particular item of marketing content. For example, with respect to distribution of marketing content to mobile devices 120, decision module 712 may compare all or a portion of data 800 to user settings and profiles of users available to receive marketing content through system 100. Users may be considered “available to receive marketing content” if they have previously registered their mobile device 120 with system 100 by, for example, downloading and installing the application on which the marketing content may be displayed. By comparing data 800 to user settings and profiles, system 100 is able to tailor marketing content to individual users of mobile device 120, and is also able to prevent an inundation of marketing content to the user. When users are inundated with marketing content, they tend to regard that marketing content as spam, and either disregard it, limit their exposure to that particular marketing channel, or come to disapprove of the business that continues to send such marketing content to them.

With respect to displaying marketing content on mobile unit 124 or display 114, decision module may still compare all or a portion of data 800 to user settings and profiles of users. Alternatively, display of the marketing content may not take into account data on nearby users, but instead may primarily focus on location and time of display of the particular item of marketing content. In either case, decision module 712 uses at least a portion of data 800 when making the determination of whether, when, and how to display particular marketing content.

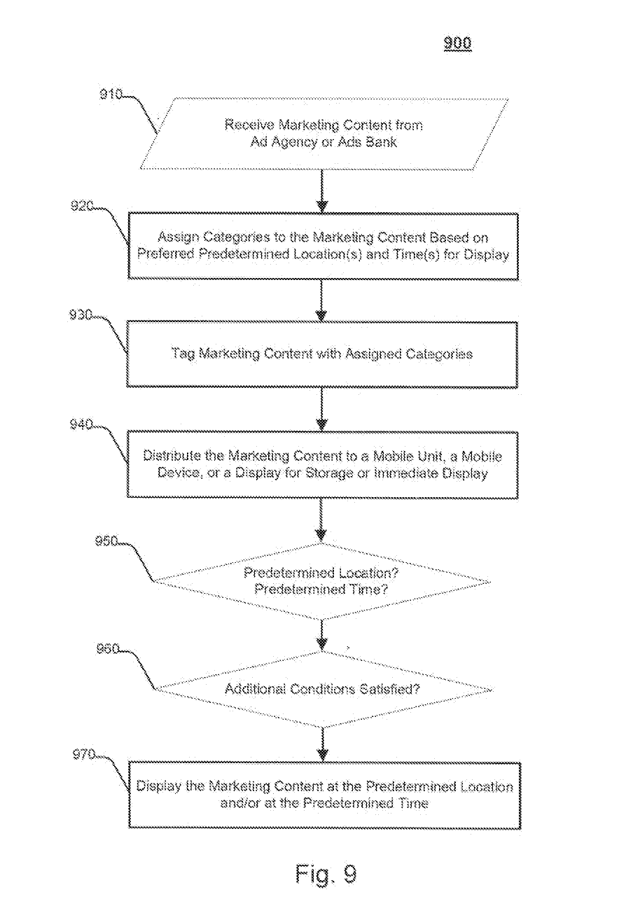

Referring to FIG. 9, an illustrative flowchart of a method for processing, distributing and displaying marketing content, according to an exemplary embodiment. This exemplary method 900 is provided by way of example, as there are a variety of ways to carry out methods according to the present disclosure. The method 900 shown in FIG. 9 can be executed or otherwise performed by one or a combination of various systems. The method 900 described below may be carried out by system 100 shown in FIG. 1 by way of example, and various elements of the system 100 are referenced in explaining the example method of FIG. 9. Each block shown in FIG. 9 represents one or more processes, decisions, methods or subroutines carried out in exemplary method 900, and these processes, decisions, methods or subroutines are not necessarily carried out in the specific order outlined in FIG. 9. As one example, the determinations reflected in blocks 950 and 960 may occur before or after distribution of the marketing material in block 940. Referring to FIG. 9, exemplary method 900 may begin at block 910.

At 910, marketing content from ad agencies 104-106 may be received at ad server 107, application server 109, network element 110, or mobile unit 124. The following embodiment involves ad server 107 receiving and distributing marketing content, but other elements shown in FIG. 1 may receive and/or distribute marketing content via network 102. Upon receiving marketing content, ad server 107 may store the marketing content in ads bank 108 or in storage module 234.

At 920, as server 107 may assign categorical data and various criteria to the marketing content to aid in distribution of the marketing content. For example, ad server 107 may assign to the marketing content criteria including a preferred predetermined location or locations for display, which may be termed a predetermined location condition. The location may be a range of particular GPS coordinates, a zip code or a portion thereof, crossroads, an individual road, a city, neighborhood, street, address, county, precinct, a proximity to a known location such as a business establishment, IP geolocation such as a list of IP addresses associated with a geographic location, and a local access and transport area (LATA) or a Numbering Plan Area (NPA) code associated with a geographic location, for example.

With regard to the location being a proximity to a known location, the known location may be related to particular businesses or individuals. The location of individuals may be determined, such as by detection of vehicle identifiers and serial numbers, including license plate numbers; financial account access location, including merchant or ATM where a credit/debit card is used; device identifiers and serial numbers; device radio signal emissions, including a roaming signal, GSM signal strength relative to a nearby antenna tower, a SIM-based round trip time and signal strength, WiFi received signal strength (RSS); biometric identifiers, including finger and voice prints, face photographic images, and any other unique identifier. Proximity may be measured as the approximate distance between any two of an individual's known location, a business location, the location of a display for displacing marketing material, or a current location of mobile unit 124.

Ad server 107 may also assign to the marketing content additional criteria such as a preferred predetermined time or times for display, which may be termed a predetermined time condition. The predetermined time may be a time of day, week, month, or year, and may also comprise a period of time that spans several seconds, minutes, hours, days, weeks, or months,. The time may also be associated with a holiday or a known event that will occur at a particular time or over a particular period, such as an election day or the first day of school. Other various categories or criteria may be assigned to the marketing content, such as those shown in FIG. 8. For example, with regard to “news,” one item of marketing content may be categorized or conditioned to be displayed when a certain event happens. Marketing content 1001, for example, may be categorized as being available for display only if a certain candidate wins an upcoming election. Similarly, other marketing content may be categorized as being available for display only when the weather is colder than 50 degrees Fahrenheit.

At 930, the assigned categories and criteria may be tagged to the marketing content, such as by adding metadata to a file containing the marketing content. Such tagging allows downstream computing devices to know how to organize and display the marketing content.

At 940, ad server 10 may distribute the marketing content to a mobile unit 124, a mobile device 120, or a display 114. Thereafter such devices may store the received marketing content within a local database or may immediately display the marketing content if the categories and criteria associated with the marketing content are satisfied.

At 950, ad server 107 or mobile unit 124, mobile device 120, or display 114 may determine whether the display, on which the marketing content will be displayed, is at the predetermined location and/or whether the predetermined time has arrived for displaying the marketing content. This determination may be made by tracking the location of the mobile display and/or monitoring the local time at the location of display.

At 960, ad server 107 or mobile unit 124, mobile device 120, or display 114 may make additional determinations regarding other categories or criteria tagged to the marketing content. Fox example, a determination may be made whether a particular event has occurred or whether particular conditions have been satisfied which are related to the subject matter of the marketing content. This determination may automatically be made by ad server 10 or mobile unit 124, mobile device 120, or display 114, after the categories and criteria are assigned to the marketing content.

At 960, the marketing content may be displayed or made available for display. The marketing content may be displayed on mobile device 120 using a push notification, text message, email or directly within an application on mobile device 120. Alternatively, the marketing content may be stored within mobile device 120 and displayed at a later time, such as when a user of mobile device 120 opens an application an mobile device 120.

In summary, embodiments may provide a system and method for presenting advertisements in realtime or near realtime based on various categories or conditions assigned to the marketing content, including but not limited to the particular location of display or time of display, and also allowing displays to work in concert and present the same or a similar marketing content to nearby potential customers on mobile devices of the potential customers.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

What is claimed is:

1. A method for displaying marketing content on a display comprising;
assigning, at a categorization module, criteria to the marketing content, the criteria comprising;
a predetermined location for display of the marketing content, and
a predetermined time for display of the marketing content;
receiving, at an input module, the marketing content;
selecting, at a decision module, which of the marketing content to display at the display based upon whether the display is located at the predetermined location and whether the predetermined time for display has arrived;
transmitting the selected marketing content upon determining that the display is located at the predetermined location and the predetermined time for display has arrived; and
displaying, at the display, the selected marketing content at the predetermined location and at the predetermined time.

2. The method of claim 1, wherein the display is on a mobile vehicle unit.

3. The method of claim 2, further comprising distributing the selected marketing content to a mobile device in a vicinity of the mobile vehicle unit.

4. The method of claim 3, wherein the mobile vehicle unit distributes the selected marketing content to the mobile device.

5. The method of claim 1, wherein the assigned criteria further comprise predetermined weather conditions at a location of the display.

6. The method of claim 1, further comprising categorizing, at the categorization module, the marketing content into categories including a type of the marketing content and a business associated with the marketing content.

7. The method of claim 1, wherein selecting which marketing content to display is based upon a comparison of the categories against user settings of a user of the mobile device.

8. The method of claim 6, wherein the marketing content is further categorized according to at least one of a discount value of the marketing content and a method of display of the marketing content.

9. The method of claim 1, wherein the selected marketing content is displayed within an application on a mobile device.

10. The method of claim 1, wherein the predetermined time for display of the marketing content is at least one of a predetermined time of day, week, month, or year.

11. A system for displaying marketing content on a display comprising:
a categorization module configured to assign criteria to the marketing content, the criteria comprising:
a predetermined location for display of the marketing content, and
a predetermined time for display of the marketing content;
an input module configured to receive the marketing content;
a decision module configured to select which of the marketing content to display at the display based upon whether the display is located at the predetermined location and whether the predetermined time for display has arrived;
a distribution module configured to transmit the selected marketing content upon determining that the display is located at the predetermined location and the predetermined time for display has arrived; and
the display, which is configured to display the selected marketing content at the predetermined location and at the predetermined time.

12. The system of claim 11, wherein the display is on a mobile vehicle unit.

13. The system of claim 12, wherein the distribution module is further configured to distribute the selected marketing content to a mobile device in a vicinity of the mobile vehicle unit.

14. The system of claim 12, wherein the distribution module is on the mobile vehicle unit and the mobile vehicle unit distributes the selected marketing content to the mobile device.

15. The system of claim 11, wherein the assigned criteria farther comprise predetermined weather conditions at a location of the display.

16. The system of claim 11, wherein the categorization module is further configured to categorize the marketing content into categories including a type of the marketing content and a business associated with the marketing content.

17. The system of claim 16, wherein the decision module is further configured to select which marketing content to display based upon a comparison of the categories against user settings of a user of the mobile device.

18. The system of claim 16, wherein the marketing content is further categorized according to at least one of a discount value of the marketing content and a method of display of the marketing content.

19. The system of claim 11, wherein a mobile device is configured to display the selected marketing content within an application on the mobile device.

20. The system of claim 11, wherein the predetermined time for display of the marketing content is at least one of a predetermined time of day, week, month, or year.
